(19) United States
(12) Patent Application Publication
(10) Pub. No.: US 2011/0184825 A1
(43) Pub. Date: Jul. 28, 2011

(54) MOBILE COMMERCE TICKETING METHOD AND APPARATUS

(76) Inventor: Christopher Christmas, Denver, CO (US)

(21) Appl. No.: 12/957,204

(22) Filed: Nov. 30, 2010

Related U.S. Application Data
(60) Provisional application No. 61/265,237, filed on Nov. 30, 2009.

(51) Int. Cl. G06Q 30/00

(52) U.S. Cl. 705/26.1

(57) ABSTRACT

A mobile commerce method and system for facilitating the same are described. In particular, the mobile commerce method employs images and image-encryption algorithms to confirm purchases. A user purchases a good and/or service and once payment has been authenticated, the authenticating entity generates a globally unique image which is transmitted back to the user's mobile communication device. The globally unique image may then be displayed on the user's mobile communication device as a proof of purchase of the good and/or service.

### CROSS REFERENCE TO RELATED APPLICATIONS

This Application claims the benefit of U.S. Provisional Application No. 61/265,237, filed Nov. 30, 2009, the entire disclosure of which is hereby incorporated herein by reference.

### FIELD OF THE DISCLOSURE

The present disclosure is generally directed toward mobile commerce and securely facilitating the same.

### BACKGROUND

Ticket purchases for admission to events and venues have traditionally been made either in person (e.g., at a ticket window), over the phone (e.g., by interacting with an automated or human ticket sales agent over the phone), or online. When tickets are purchased in person, they can be immediately remanded to the purchaser. When tickets are purchased over the phone or online, the tickets usually have to be shipped to the purchaser or kept at the location of the event or venue for the purchaser to redeem upon arrival.

While purchasing tickets in person is the most secure way to obtain a ticket it is also the most time consuming. Specifically, the purchaser is able to physically obtain their ticket immediately upon rendering payment when the ticket is purchased in person. However, this security requires the user to travel to a designated point of purchase. Conversely, purchasing tickets over the phone or online provides purchasers with more purchasing flexibility, but is less secure. Specifically, the purchaser is able to purchase from virtually any location, but the purchaser does have the ability to receive their tickets immediately.

In all scenarios, there exists the potential for the physical ticket to be lost, stolen, or otherwise compromised. When this happens to a ticket, the original purchaser of the ticket (i.e., the true owner of the ticket) may not be able to gain admission to the event or venue.

The same problem arises when goods and/or services are purchased online or over the phone. More specifically, there is not a current way to secure mobile commerce while also making it user-friendly. It is also difficult for vendors and providers to confirm that a purchase has actually been made based on confirmation emails or the like, which can be easily fabricated, duplicated, copied, forwarded, etc. Thus, most vendors and providers do not rely solely on confirmation emails as a proof of purchase.

### SUMMARY

It is with respect to the above issues and other problems that the embodiments presented herein were contemplated.

In some embodiments, a method is provided which generally comprises:

purchasing a ticket to a venue or event;

confirming the purchase;

after the purchase has been confirmed, receiving cover art or graphics at a mobile communication device, the cover art or graphics being unique to the venue or event;

thereafter, presenting the mobile communication device at point of sale or entry (e.g., to a venue attendant) of the venue or event; and

the cover art or graphics altering, for example to an animation or alternative cover art or graphics, to confirm validity of ticket purchase.

Aspects of the present disclosure may be extended beyond the purchase of tickets to venues or events. In particular, embodiments of the present disclosure may be leveraged to facilitate mobile exchanges of goods and/or services. More specifically, a user may be enabled to pay for a particular good and/or service via their mobile device, receive a globally unique image indicating that the user has made such a purchase and further enabling the user to present such image as a proof of purchase.

In some embodiments, the exchange of payment information and/or the globally unique image may secured via encryption or some other security algorithm. Because the image is encrypted, it may be transmitted over communication networks using traditional communication protocols.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting a data structure used in accordance with embodiments of the present disclosure;

FIG. 3 is a flow diagram depicting a mobile purchase method in accordance with embodiments of the present disclosure;

FIG. 4 is a flow diagram depicting a payment verification and image-generating method in accordance with embodiments of the present disclosure;

FIG. 5 is a flow diagram depicting a method of redeeming goods and/or services with a uniquely-generated image displayed on a user's mobile device in accordance with embodiments of the present disclosure; and

FIG. 6 is a flow diagram depicting an image encryption method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

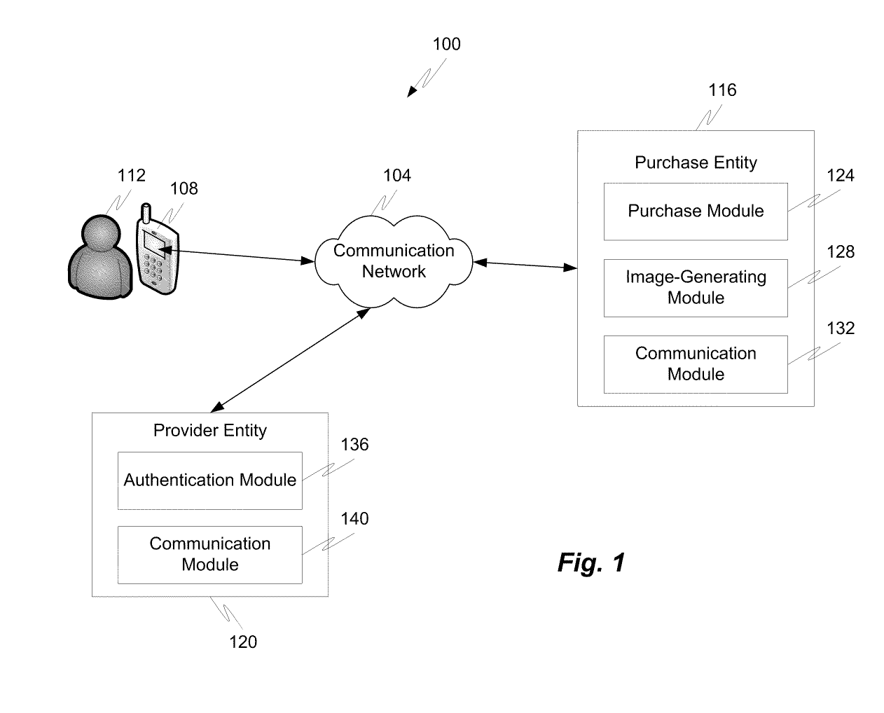

FIG. 1 shows an illustrative embodiment of the present disclosure. In particular, FIG. 1 depicts a communication system 100 in which a user 112 is enabled to purchase a good and/or service with their mobile communication device 108 and utilize the mobile communication device 108 to render an image as a proof of purchase of the good and/or service.

In accordance with at least some embodiments of the present disclosure, a good and/or service refers to any type of commodity, consumer good, product, tangible item, intangible item, service, collection of services, right of entry to a venue, right of entry to an event, or any other type of thing which can otherwise be purchased with currency.

The mobile communication device 108 may correspond to any type of hand-held computing and/or communication device. Suitable types of mobile communication devices 108 include, without limitation, a cellular phone, a smart phone, a laptop, a tablet, a netbook, a Personal Digital Assistant (PDA), or the like. In one embodiment, the mobile communication device 108 corresponds to a cellular phone having both the capability of establishing a communication session with other mobile communication devices via a cellular network as well as the capability of exchanging information with web servers or light-weight web servers (e.g., mobile web servers) which provide web-based content to mobile communication devices 108 using a known Internet Protocol (e.g., http, https, ftp, etc.).

Accordingly, the communication network 104 may correspond to any IP network, such as the Internet, a LAN, a Wide Area Network (WAN), a 3G network, a 4G network, or combinations thereof. In accordance with at least some embodiments, the network 104 is adapted to carry messages between the components connected thereto. The network 104 may comprise any type of known communication network including wired and wireless or combinations of communication networks and may span long or small distances. The protocols supported by the network 104 include, but are not limited to, the TCP/IP protocol, Wi-Fi, RS 232, Bluetooth, GSM, SMS, optical, audio and so forth. The Internet is an example of the network 104 that constitutes a collection of IP networks consisting of many computers and other communication devices located locally and all over the world.

In some embodiments, the communication network 104 may also include one or more of a standard Plain Old Telephone System (POTS), an Integrated Services Digital Network (ISDN), the Public Switched Telephone Network (PSTN), a Session Initiation Protocol (SIP) network, a cellular communication network, a satellite communication network, any type of enterprise network, and any other type of packet-switched or circuit-switched network known in the art. It can be appreciated that the communication network 104 need not be limited to any one network type, and instead may be comprised of a number of different networks and/or network types.

In some embodiments, the user 112 employs their mobile communication device 108 to exchange one or more messages over the communication network 104 with a purchase entity 116 to complete a transaction for goods and/or services. In particular, the purchase entity 116 may utilize a server, such as a web server, that includes a processor and a number of instructions executable by the processor in the form of one or more modules. The types of modules which may be included on the server operated by the purchase entity 116 include, without limitation, a purchase module 124, an image-generating module 128, and a communication module 132.

Transactions completed between the purchase entity 116 and the mobile communication device 108 may be memorialized by the generation of a globally unique image at the purchase entity 116 that is transmitted to the mobile communication device 108. The user 112 may then present the mobile communication device 108 to a provider entity 120 to redeem the good and/or service purchased via the purchase entity 116. In particular, the globally unique image generated by the purchase entity 116 may be presented via the mobile communication device 108 to the provider entity 120 to prove the transaction made at the purchase entity 116. In some embodiments, the provider entity 120 may correspond to a system that employs one or more servers incorporating an authentication module 136 and communication module 140 and one or more reader devices in communication with the server. Alternatively, the provider entity 120 may comprise one or more reader devices, each of which include an authentication module 136 and communication module 140. Alternatively, the provider entity 120 may comprise a single server or single computing device that includes the authentication module 136 and communication module 140.

In some embodiments, the mobile communication device 108 may be purchasing one or more goods and/or services that are offered (i.e., are made redeemable) by a provider entity 120. In some embodiments, the provider entity 120 and the purchase entity 116 may be the same entity, which means that the user 112 completes the purchase transaction with the same entity that will ultimately be responsible for rendering the purchased good and/or service. In such embodiments, the modules associated with the purchase entity 116 and provider entity 120 may be provided on a single server or may distributed among a plurality of different devices that are administered by the purchase/provider entity.

In some embodiments, the provider entity 120 and purchase entity 116 are separate entities and the purchase entity 116 merely facilitates the purchase of a good and/or service on behalf of the provider entity 120. In these embodiments, it may be necessary for the purchase entity 116 to communicate information to the provider entity 120 which will enable the provider entity 120 to verify that an image presented by a mobile communication device 108 is, in fact, an authentic and valid image that was generated by the image-generating module 128 of the purchase entity 116.

The communication modules 132, 140 enable the various entities to communicate with one another over the communication network 104. In some embodiments, the communication modules 132, 140 comprise instructions which enable messages to be generated, packetized, modulated, encrypted, demodulated, decrypted, depacketized, and the like in a format compliant with a transmission protocol supported by the communication network 104. Thus, the communication modules 132, 140 facilitate communications over the communication network 104.

The purchase module 124 is responsible for enabling a user 112 to complete a purchase transaction. In some embodiments, the purchase transaction is executed between the mobile communication device 108 and the purchase entity 116. In other embodiments, a user may utilize a device other than their mobile communication device 108 to complete a purchase transaction, but may provide the purchase entity 116 with the phone number of their mobile communication device 108 such that the purchase entity 116 can transmit images to the designated phone number, thereby providing the mobile communication device 108 with the proof of purchase in the form of one or more images.

The purchase module 124 comprises the necessary instructions, typically in the form of webpages, that enable a user 112 to purchase one or more goods and/or services remotely. The purchase module 124 may, therefore, also comprise instructions for establishing a secure connection (e.g., encrypted connection) over the communication network 104 so that user information, credit card information, and other sensitive information can be provided to the purchase entity from the user 112. This information can be used for two purposes. The first reason is to complete the transaction. The second reason is to utilize some or all of the user information as an input to the image-generating module 128.

When the transaction has been successfully completed, the purchase module 124 may pass the processing responsiblities to the image-generating module 128, which generates one or more globally unique images based on the completed transaction. In some embodiments, the image-generating module 128 utilizes user information (e.g., user name, password, portions of credit card information, phone number of the mobile communication device 108, etc.), user location information (e.g., GPS coordinates calculated by the mobile communication device 108 upon completion of the transaction), and other variable information that is likely to change over time and across different users. By utilizing a number of different and variable inputs, the image-generating module 128 is capable of generating a globally unique image (i.e., an image not duplicated for any other user or different purchase by the same user) that represents a proof of purchase. As will be discussed in further detail herein, the image-generating module 128 may utilize one or more image encryption algorithms to encrypt information in one or more randomly selected pixels of the image. In some embodiments, the image-generating module 128 alters one or more of pixel patterns and pixel density of a base image in a way that is unique to the user 112. The extent to which such image adjustments are made can vary depending upon the inputs used by the image-generating module 128. Such information may then be decrypted when read by an authentication module 136 of the provider entity 120 to confirm the image presented by the mobile communication device 108 is valid. A single copy of the globally unique image may be transmitted from the purchase entity 116 to the provider entity 120 which utilizes the authentication module 136 to compare its version of the image with an image presented by the mobile communication device 108.

Once the globally unique image has been generated and transmitted to the mobile communication device 108, a single copy of the globally unique image may be transmitted from the purchase entity 116 to the provider entity 120 which utilizes the authentication module 136 to compare its version of the image with an image presented by the mobile communication device 108. Alternatively, only a single image may be transmitted to the mobile communication device 108 and when the image is presented to the authentication module 136, the authenticity of the image is proved based on the fact that the image alters, for example by becoming first becoming pixelated and then by becoming an animation or by changing to a second image that corresponds to an image that is expected and recognized by the authentication module 136.

Upon verifying the authenticity of the image presented by the mobile communication device 108, the provider entity 120 may remit the purchased good and/or service or allow the user 112 entry to a venue or event, depending upon the nature of the good and/or service purchased.

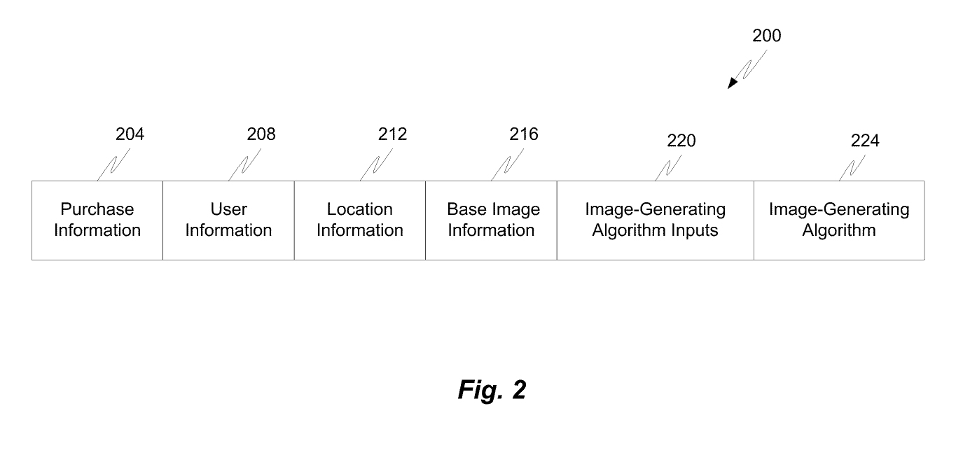

With reference now to FIG. 2, a data structure 200 used by the purchase entity 116 and/or provider entity 120 to generate and/or confirm validity of an image will be described in accordance with at least some embodiments of the present disclosure. The data structure 200 may include one or more data fields which enable the generation, transmission, or confirmation of validity of an image. Examples of such fields include, without limitation, a purchase information field 204, a user information field 208, a location information field 212, a base image information field 216, an image-generating algorithm input field 220, and an image-generating algorithm field 224.

The purchase information field 204 may comprise the information used during the transaction. In some embodiments, the purchase information field 204 may comprise information such as user name, address, credit card information (or other payment information), and any other information that was provided from the user 112 to the purchase module 124 during completion of the transaction to purchase the good and/or service in question.

The user information field 208 may comprise information which identifies the user 112. In some embodiments, the user may be identified by user name and/or password combinations. In some embodiments, the user may be identified by their given name, portions thereof, aliases, or unique identification numbers assigned to the user 112 by the purchase entity 116 (e.g., customer number).

The location information field 212 may comprise information related to the location of the user 112, or more specifically the mobile communication device 108 being carried by the user 112, at the time the transaction was completed, at the time the image was generated, at the time the image was received, or at the time the image is presented to the provider entity 120 for authentication. In some embodiments, the mobile communication device 108 provides location information in the form of GPS information to the purchase module 124 as part of the transaction process. The GPS information may be provided in a common format (i.e., latitude and longitude). Alternatively, the location information may correspond to location information determined for the mobile communication device 108 using cellular location techniques (i.e., cellular triangulation).

The base image information field 216 may comprise basic information used by the image-generating module 128 to generate the globally unique image representing a proof of purchase. In some embodiments, the base image information is provided as pixel information and may be in any type of image file format (e.g., .jpg, .bmp, .pdf, .tiff, .gif, etc.). The base image information may be generic and may be reused as base image information for generating many different globally unique images.

The image-generating algorithm inputs field 220 may comprise information which identifies the variables to be used by the image-generating module 128 when creating the globally unique image. In particular, data from the other data fields in the data structure 200 may be referenced by (e.g., through pointers) or copied in the image-generating algorithm inputs field 220. The information in this particular field can be used as an algorithmic input for the image-generating module 128 when creating the globally unique image. In some embodiments, selected user data, location data, and other data used by the purchase module 124 may be used as an input for altering the base image information 216 to create the globally unique image.

The image-generating algorithm field 224 may comprise the algorithm used by the image-generating module 128 in generating the globally unique image. In particular, the algorithms may include any type of image encryption algorithms, watermark generating algorithms, etc. In some embodiments, the algorithm used by the image-generating module 128 corresponds to an encryption algorithm which selects one or more pixels in the base image and encrypts those pixels to create unique watermarks in the globally unique image. The selection of pixels and encryption inputs may based, at least in part, upon information in the image-generating algorithm inputs field 220.

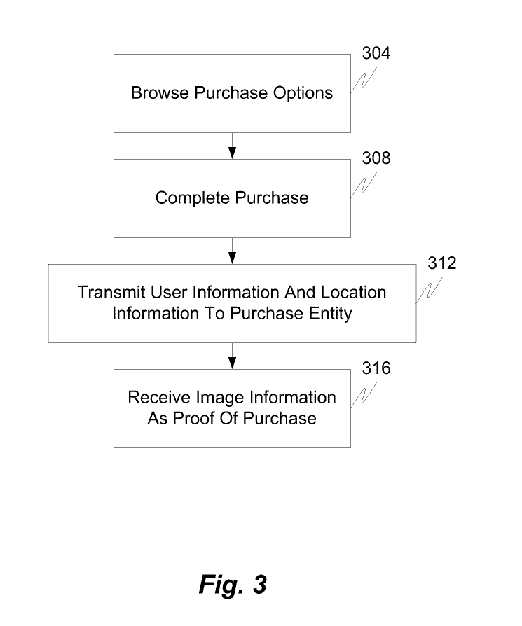

With reference now to FIG. 3, a method of conducting a transaction will be described in accordance with at least some embodiments of the present disclosure. As noted above, the purchase method described herein may be conducted with the mobile communication device 108 or with some other computing device that has a web browser. The purchase module 124 operated by the purchase entity 116 may be responsible for facilitating most or all of the features discussed in connection with the transaction method of FIG. 3.

The method begins when a user 112 is allowed to browse purchase options offered by a provider entity 120 (step 304). In some embodiments, the purchase options may correspond to available goods and/or services, data related to such goods and/or services, and prices associated therewith. In some embodiments, the purchase options may include options for purchasing one or more tickets to a venue or event and locations of seats at the venue or event.

As the user 112 browses the purchase options, the user may select one or more goods and/or services for purchase. In a known fashion, the user 112 may add goods and/or services to a virtual shopping cart until the user 112 is ready to complete the transaction and “check out”. After the user 112 is done browsing the purchase options, the purchase is completed (step 308). In this step, the user 112 may confirm the goods and/or services to be purchased and enter a secure portal to exchange sensitive information with the purchase module 124.

Thereafter, the user 112 may provide the purchase module 124 with payment (e.g., via a gift card or money order) or information entitling the purchase entity 116 to receive payment from a third party (e.g., credit card information, debit card information, etc.) (step 312). The user 112 may also provide user information as part of completing the transaction. In some embodiments where the transaction is being completed with a mobile communication device 108, the mobile communication device 108 may also provide location information for the device 108. In some embodiments, the location information may be provided automatically. In some embodiments, the location information may be provided only after the user 112 has confirmed that providing such information is allowed. In embodiments where a mobile communication device 108 is not used to complete the transaction, the user 112 may also need to provide the purchase entity 116 with a number of the mobile communication device 116 so that image information can be transmitted to the mobile communication device 116.

After the requisite information has been provided to the purchase entity 116, the purchase entity 116 continues by generating a globally unique image and then transmitting that image information to the mobile communication device 108. The image information is then received at the mobile communication device 108 and stored in its local memory (e.g., in a Subscriber Identity Module (SIM) card, in local phone memory, or in a USB peripheral memory). The image information is maintained as a read only data structure or file until it needs to be presented as a proof of purchase.

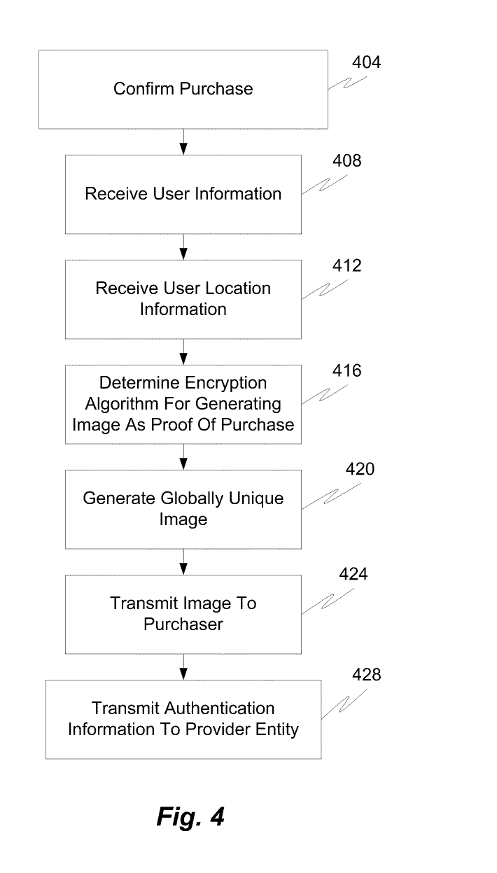

Referring now to FIG. 4, a payment verification and image-generating method will be described in accordance with at least some embodiments of the present disclosure. The method is initiated when the purchase is confirmed by the purchase module 124 (step 404). Thereafter, the user information and user location information to be used as inputs to the image-generating algorithm are received at the image-generating module 128 (steps 408, 412). The image-generating module 128 then determines the algorithm(s) which will be used to generate the globally unique image (step 416) and the inputs for the algorithm.

Thereafter, the image-generating module 128 generates the globally unique image with the selected algorithm (step 420). In some embodiments, generating the globally unique image may comprise algering a generic image and altering selected pixel data of that image. In some embodiments, generating the globally unique image may comprise altering pixel organization and/or density with an encryption algorithm.

The globally unique image is then transmitted to the purchaser (step 424). More specifically, the pixel data representing the globally unique image is encoded in a message or the globally unique image file is appended to a message and transmitted to the mobile communication device 108. A copy of the globally unique image or information that can be used to decrypt or confirm validity of the globally unique image may also be transmitted to the provider entity 120, if the purchaser entity 116 is different from the provider entity 120 (step 428).

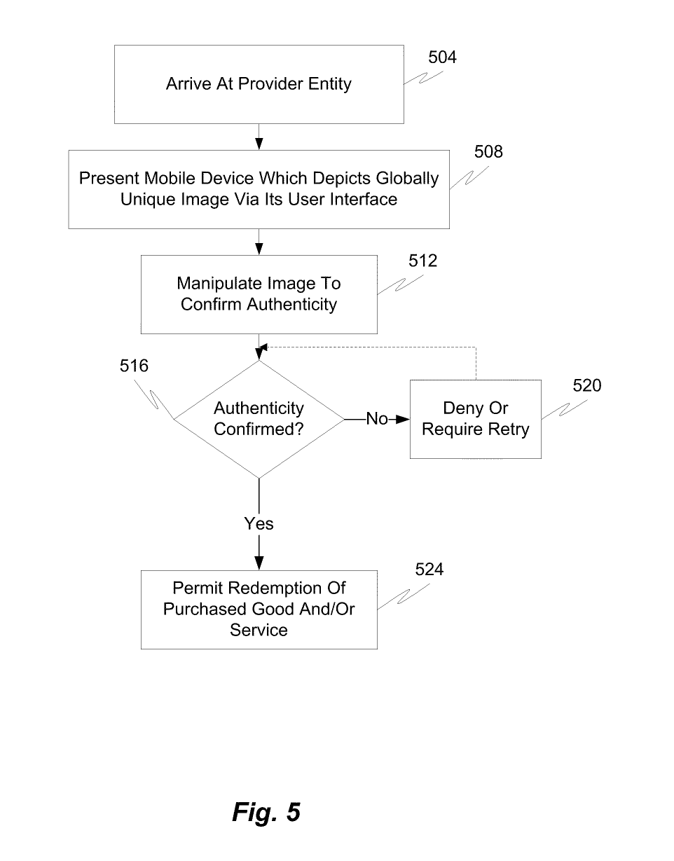

Referring now to FIG. 5, a method of redeeming goods and/or services with a uniquely-generated image displayed on a mobile communication device 108 will be described in accordance with at least some embodiments of the present disclosure. The method begins when a user 112 arrives at a provider entity 120 (step 504). Upon arrival, the user 112 presents their mobile communication device 108, which depicts the globally unique image via its user interface (step 508). In some embodiments, the image is displayed in a first state. Upon receiving a prompt from the authentication module 136 or from the user 112, the image may then change to pixels and then to an animation (step 512). The manner in which the image is manipulated may depend upon the manner in which it was generated. For example, a first type of manipulation may occur for a first user whereas a second type of manipulation may occur for a second user. Only authentic images (i.e., images which truly represent a proof of purchase) may be configured to alter from an image to a pixelated version of the image and then to an animation. Thus, if security personnel or a sales clerk at the provider entity 120 witnesses the alteration of the image according to the appropriate pattern, then security personnel or sales clerk can verify that the image presented is authentic and the user has validly purchased the good and/or service in question (step 516). If the authenticity of the image is confirmed via this process, then the user 112 is permitted to redeem the purchased good and/or service (step 524). Otherwise, the user 112 will be required to reprove the image's authenticity or will be denied the good and/or service (step 520).

In some embodiments, the image may only be manipulated by the mobile communication device 108 to which it was transmitted. This precludes the ability to use a single image to redeem multiple goods and/or services or to transfer the image to non-purchasing parties. More specifically, if the image was generated based on current location information of the mobile communication device 108 at the time of purchase, only the purchasing entity 116 and the mobile communication device 108 that completed the purchase will know of the location information. Because the image was generated based, at least in part on this location information, only the purchasing mobile communication device 108 will be permitted to manipulate the image once it is received. Any other device will not have access to the location information and will, therefore, be unable to manipulate the image to prove its authenticity.

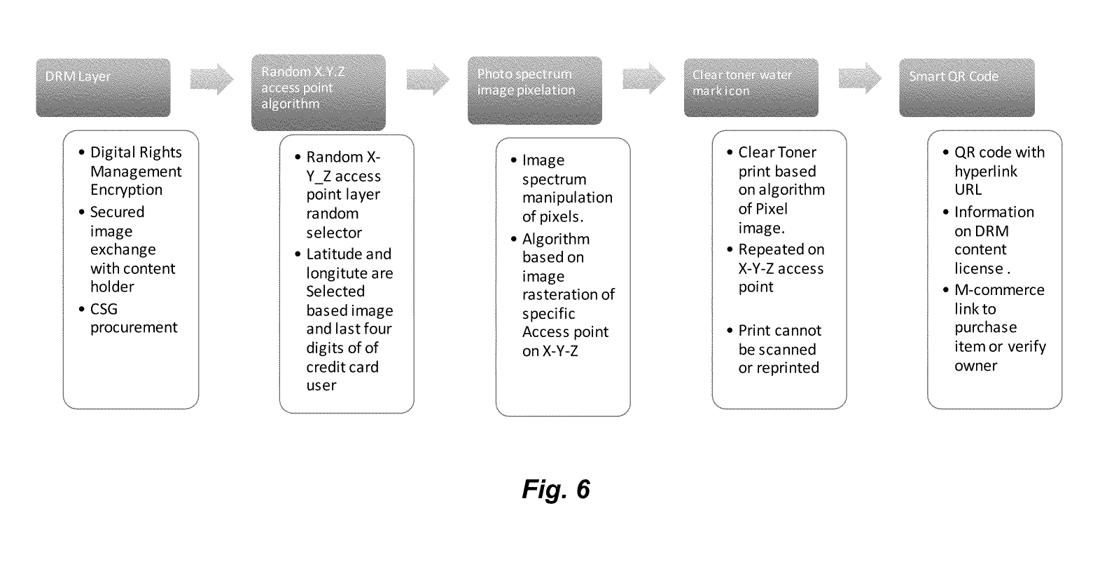

With reference now to FIG. 6, an exemplary image encryption method is depicted in accordance with at least some embodiments of the present disclosure. Specifically, the Digital Rights Management (DRM) layer is encrypted and secured such that it can be exchanged with the mobile communication device 108. Then random points on the image are selected for pixelation and/or alteration. Then photo spectrum image pixelation is used to alter the selected pixels. The image is then generated and it includes watermarks which can provide a proof of unauthorized copying of the image. The image can then be used as a proof of purchase.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
confirming that a purchaser has rendered payment for at least one of a good and service;
obtaining information associated with the confirmed purchase;
generating a globally unique image with an image-generating algorithm which uses as an input at least some information associated with the confirmed purchase; and
transmitting the globally unique image to a mobile communication device associated with a purchaser.

2. The method of claim 1, wherein the information associated with the confirmed purchase comprises location information of the mobile communication device at the time the rendered payment.

3. The method of claim 2, wherein the information associated with the confirmed purchase further comprises information which identifies the purchaser.

4. The method of claim 1, wherein the globally unique image comprises at least some pixel data that has been encrypted to create a watermark.

5. The method of claim 1, wherein the at least one of a good and service comprises a ticket or right to enter at least one of a venue and event.

6. The method of claim 1, further comprising:
altering the globally unique image according to a predetermined pattern as a proof of purchase of the at least one of a good and service.

7. A computer readable medium having stored thereon instructions that cause a computing system of a purchaser entity to execute a method, the instructions comprising:
instructions configured to confirm the purchase of a ticket to a venue or event by a purchaser;
instructions configured to, after the purchase has been confirmed, generate graphics for transmission to a mobile communication device, the graphics being unique to the venue or event and the purchaser; and
instructions configured to enable the graphics to be altered only by the mobile communication device at a point of entry to the venue or event in accordance with a predetermined pattern to reflect that the graphics are a proof of purchase.
